(19) United States
(12) Patent Application Publication
(10) Pub. No.: US 2017/0342769 A1
(43) Pub. Date: Nov. 30, 2017

(54) WINDOW ACCESSORY AND METHOD OF DECORATION

(71) Applicant: Theon Holland, North Beach, MD (US)

(72) Inventor: Theon Holland, North Beach, MD (US)

(21) Appl. No.: 15/162,764

(22) Filed: May 24, 2016

(51) Int. Cl. E06B 9/24; B32B 17/10

(52) U.S. Cl. CPC E06B 9/24; B32B 17/10247; B32B 2451/00; B32B 2307/42; E06B 2009/2488; B32B 2419/00

(57) ABSTRACT

A window decoration system that includes: a plastic insert, where the plastic insert is adapted for placement onto glass; and placement of the plastic insert onto the inside surface of a window. The plastic insert may preferably be placed at a top edge of the window.

### BACKGROUND OF THE INVENTION

### Field of Invention

The present invention relates to a window accessory as used to further decorate an existing window.

### Description of Related Art

Windows form a critical aspect of most residential homes. Some functional aspects of windows include the ability to allow the flow of fresh air into the home and to prevent the entry of weather conditions into the home. The windows overall may enhance the appearance of the residential structure based upon shape, size and style. Some methods of enhancing the window's appearance include use of curtains, blinds and other decorative measures, which are usually seen through the window from the outside view. However, in general there are limited choices with respect to window enhancement based upon general decorative techniques. As a result, it would be advantageous to have a device that could be used to easily adorn the exterior appearance of a window and that could be easily interchanged based upon taste and desires.

### SUMMARY OF THE INVENTION

The present invention relates to a window decoration system that includes: a plastic insert, where the plastic insert is adapted for placement onto glass; and placement of the plastic insert onto the inside surface of a window. The plastic insert may preferably be placed at a top edge of the window.

### BRIEF DESCRIPTION OF DRAWINGS

FIG. 1 depicts the use of a window surface insert in accordance with the present invention.

### DETAILED DESCRIPTION

The present invention relates to a device and method to enhance window appearance. This particular device is applied directly to the window in the form of a plastic insert. The plastic adheres to the surface of the window and creates a unique exterior appearance when viewed from the outside of the residential building. The present invention is preferably made of plastic materials in the form of PVC. The application of this plastic overlay may be implemented at any location along the window surface however preferably is applied at the top edge of the window surface. Once applied to this top edge the window appearance changes dramatically on the exterior view.

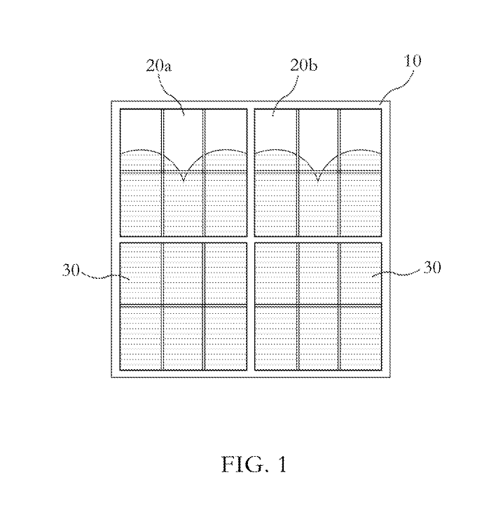

A Plastic Window Insert 20a, 20b is shown in FIG. 1. As shown, the plastic insert 20a, 20b are attached to a top edge of a window frame 10. The window frame 10 surrounds the plurality of Window Panes 30 shown in FIG. 1. A user may apply this Plastic Insert 20 onto the window's surface. The resulting view is therefore dramatically changed. Further, the Plastic Insert 20 may also serve as a filtering mechanism to filter sunlight into the interior of the building. The instant invention has been shown and described in what it considers to be the most practical and preferred embodiments. It is recognized, however, that departures may be made there from within the scope of the invention and that obvious modifications will occur to a person skilled in the art.

1. A window decoration system comprising:
a. a plastic insert, where the plastic insert is adapted for placement onto glass and said plastic insert filters incoming light; and
b. placement of the plastic insert onto the inside surface of a window.

2. The window decoration system according to claim 1, where the plastic insert is placed at a top edge of the window.
